(19) United States
(12) Patent Application Publication
(10) Pub. No.: US 2005/0121953 A1
(43) Pub. Date: Jun. 9, 2005

(54) Motorcycle seat

(76) Inventor: Anthony Eric Sprouse II, Shiloh, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/003,777

(22) Filed: Dec. 3, 2004

Related U.S. Application Data
(60) Provisional application No. 60/526,487, filed on Dec. 3, 2003.

(51) Int. Cl. B62J 1/26

(52) U.S. Cl. 297/199

(57) ABSTRACT

A motorcycle seat having a rigid support, a shock absorbing foam base on the support with air cell cushions inserts positioned under the ischial areas of the rider, and a cover. The air cell cushion comprises a base and a plurality of interconnected air cells. The air pressure within the air cell cushion is adjusted to comfort by the operator, either through an independent air pump or a built-in pump. The air cell cushion is designed to evenly distribute supportive force generally evenly across its surface.

### CROSS REFERENCE TO RELATED APPLICATIONS

This application claims priority to provisional application Ser. No. 60/526,487, filed Dec. 3, 2003, which is incorporated herein by reference.

### BACKGROUND OF THE INVENTION

This invention relates to vehicle seats in general, and more specifically to cushioned seat or saddle for use on a motorcycle.

A well-recognized problem for Individuals who spend extended time seated on a motorcycle is that the rider can experience soreness in the area buttocks and legs, commonly referred to as being saddle sore. This problem can be compounded by the fact that some motorcycles are prone to vibration or do not have particularly efficient shock absorbing or dampening structures. Consequently, the rider not only experiences soreness, but also can experience numbness or loss of feeling in the buttocks, particularly the ischial areas, and in upper legs or thighs. It would be advantageous for riders who typically travel many miles on a cruiser style motorcycles to have a cushioned motorcycle saddle that provides optimum support under the ischial areas and also dampens or absorbs road shock and vibration.

### SUMMARY OF THE INVENTION

It is among the various aspects and objects of the invention to provide a motorcycle seat comprising a support, a shock absorbing foam base with air cell cushions inserts positioned under the ischial areas of the operator and the passenger. The air cell cushion comprises a base and a plurality of interconnected upstanding air cells. The air pressure within the air cell cushion is adjusted to comfort by the operator, either through an independent air pump or a built-in pump. The air cell cushion is designed to evenly distribute supportive force generally evenly across its surface.

The support is semi-rigid in that it may accommodate some flexure, and is constructed of appropriate, such as fiberglass or metal and contoured to mount atop the motorcycle frame. The entire saddle is covered with an appropriate wear resistant material, such as leather or water repellant fabric. The cover at the area of the air cell cushion generally is elastic to get the maximum benefit of the air cell cushion.

### BRIED DESCRIPTION OF THE DRAWINGS

FIG. 1 is a top perspective view of a motorcycle seat of the present invention;

FIG. 2 is a bottom perspective view thereof;

FIG. 3 is a perspective view of the foam cushion;

FIG. 4 is a perspective view of the foam cushion with a deflated air cell cushion in place at the operator's position;

FIG. 5. is a perspective view of an inflated air cell cushion;

FIG. 6 is a partial perspective view of the foam cushion with a deflated air cell cushion in place at the passenger's position;

FIG. 7. is a top plan view of another configuration of an air cell cushion;

FIG. 8 is a top plan view, partially cut away, of an alternative configuration of a motorcycle seat of the present invention; and

FIG. 9 is a perspective view of another alternative configuration of a motorcycle seat of the present invention, without a cover.

### DESCRIPTION OF THE PREFERRED EMBODIMENT

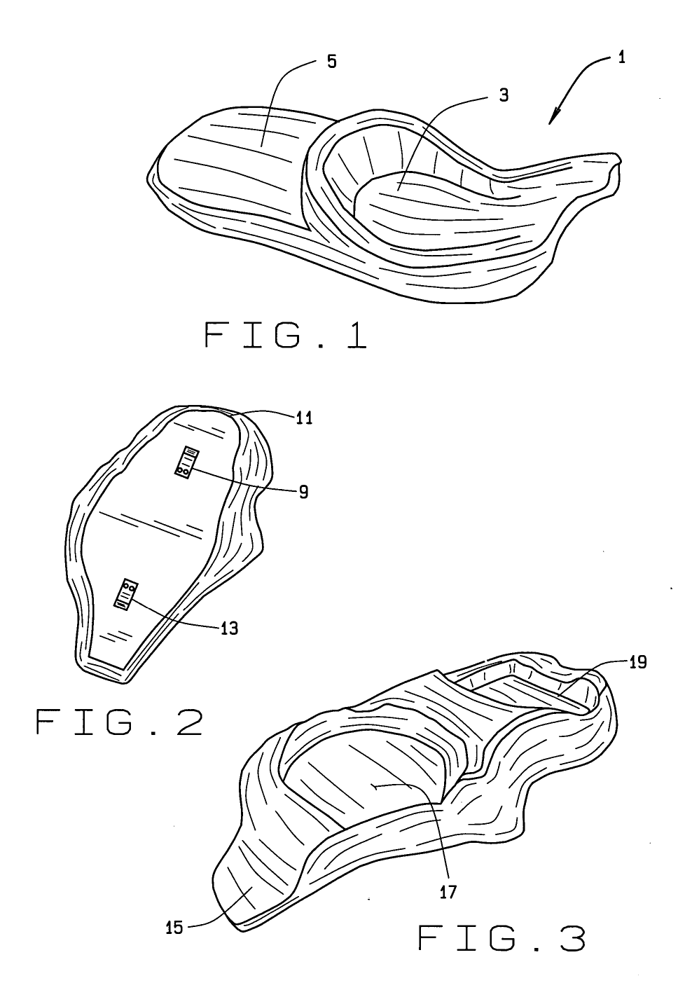

A motorcycle seat of the present invention is indicated generally as reference numeral 1 in FIG. 1. As shown, seat 1, is a generally elongated saddle style having a front operator's seat 3 and a rear passenger seat 5. Seat 1 is shown with a leather seat cover 7.

FIG. 2 illustrates the bottom side of seat 1 and shows the support 9 with mounting hardware 11, 13. Support 9 is semi-rigid and supportive and may have minimal flex. As shown, support 9 is substantially elongated having a peripheral configuration of the desired configuration of seat 1. The support can be fashioned from appropriate material such as fiberglass, sheet metal, tubular metal or the like. Mounting hardware 11, 13 allow attachment of the seat to the top surface of a motorcycle frame (not shown) generally behind or above the gas tank.

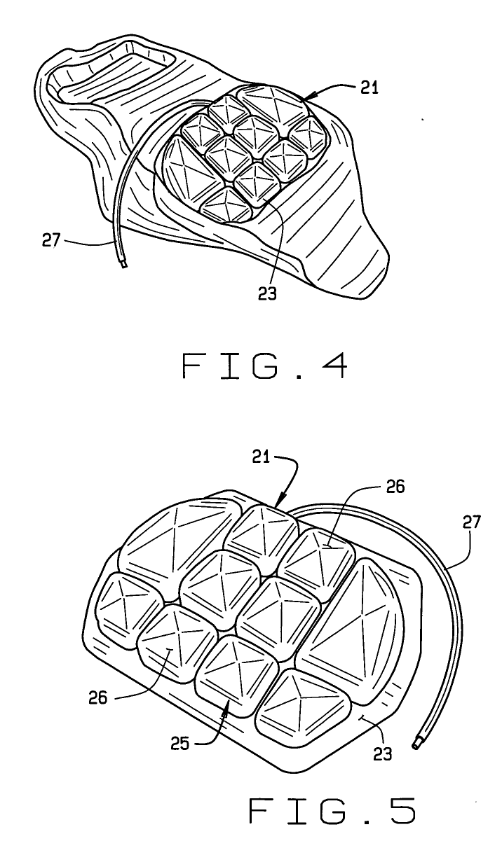

Seat 1 comprises a shock absorbing foam base 15, as seen in FIG. 3. Foam base has a peripheral configuration complementary to that of the support imparting the overall desired configuration to the seat. Foam base 15 is bonded or otherwise appropriately attached to support 9. As shown, base 15 includes a front cavity 17 corresponding to the operator's seat position and a rear cavity 19 corresponding to the passenger's seat position. The cavities are formed in the base to contain an air cell cushion, as will now be explained.

FIG. 4 illustrates a deflated air cell cushion 21 positioned in cavity 17. As best seen in FIG. 5, air cell cushion 21 is comprised of a base 23 and a plurality of interconnected air cells 25 that stand erect, when inflated, as better seen in FIG. 5. The cells illustrated in FIG. 5 each include 4 fins 26, however, the cells can include any suitable number of fins and comprise other configurations, such as domed, rectangular or the like. The cells are arranged in transverse and longitudinal rows to form an array. The cushion can be formed from dip-molded neoprene in accordance with principals taught in U.S. Pat. No. 4,541,136 or U.S. Pat. No. 4,005,236, which are incorporated herein by reference. The cells can be formed from vacuum molded plastic material as well. Cushion 21 includes an air inflation tube 27. The cells 25 are interconnected so that when the air cells are inflated through tube 27 all will exist at the same pressure.

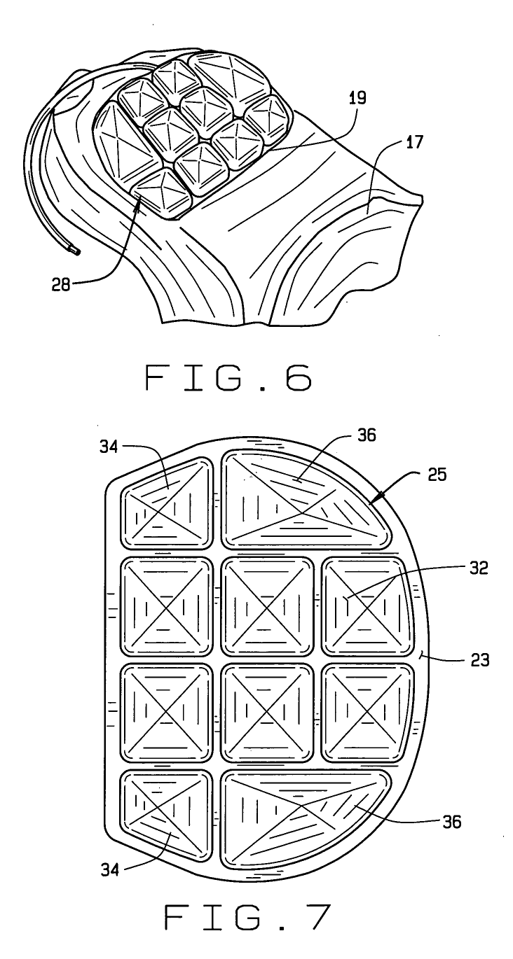

The cushion will exert a generally uniform force or pressure on the surface area of the body supported on it. Thus, the user does not feel discomfort from seat pressure, for example under the ischial area, or the lower portion of the hip bone affording a more comfortable ride over long periods. The cell structure also relieves pressure on nerves that can result in tingling and numbness in the legs and hips. The cells can be interconnected with an airflow pattern that enhances the shock absorbing characteristics of the cushion, as disclosed in U.S. Pat. No. 6,687,936, which is incorporated herein by reference. FIG. 6 shows an air cell cushion 28 in rear cavity 19. Cushion 28 has the same general structure and function as air cell cushion 21. FIG. 7 better illustrates the embodiment of a preferred arrangement of the cells 25 in an array on air cell cushion 21. This arrangement includes ischial support cells 32, transitional cells 34 and lateral rear bolster cells 36.

It will be appreciated that the illustrated cavities 17 and 19 are formed in foam base 15 so that they are position under the ischial area of an operator of the motorcycle and a passenger, respectively. Consequently, when the air cell cushions are positioned in the respective cavities, the air cell cushions are appropriately positioned under the ischial areas of the operator and passenger.

Although the illustrated embodiment of the cushion shows an inflation tube 27 that used with a separate pump or air supply, seat 1 also can have a bulb pump attached to the inflation tube. The bulb is discreetly housed in the seat but minimally exposed for access. Also, the seat and cushion can have a built in pump, similar to the type of pump disclosed in U.S. Pat. No. 6,287,225, the disclosure of which is incorporated herein by reference.

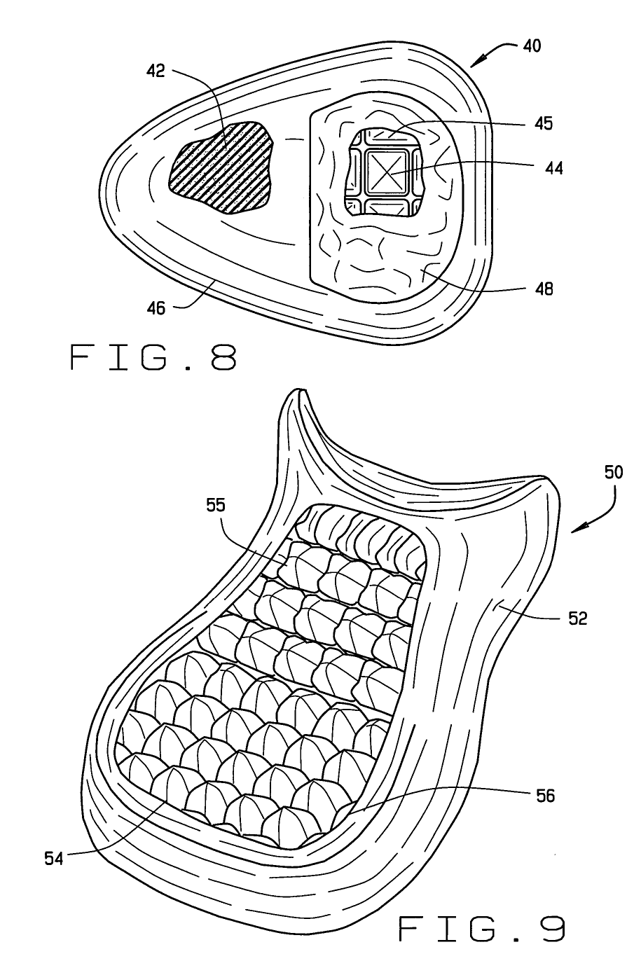

FIG. 8. illustrates another configuration of motorcycle seat 40. Seat 40 has a substantially triangular or traditional single passenger configuration. The seat includes a foam base 42, and an air cell cushion 44 comprising an array of individual air cells 45 positioned in a cavity in the foam base under the ischial area of the operator. Seat 40 includes a cover 46, in this example a leather cover that has a stretchable fabric area 48 positioned over the air cell cushion to allow optimal deflection and equalization of pressure of the air cells 45. The fabric also generally is durable and waterproof.

FIG. 9 illustrates another configuration of a motorcycle seat, indicated generally by reference numeral 50. Seat 50 has a more traditional saddle style configuration with a support (not shown), a foam base 52 and an air cell cushion 54. The air cell cushion is comprised of an array of interconnected four fin air cells 55. Base 52 has a cavity 56 that extends nearly the length and width of the base. The air cell cushion 54 is positioned within cavity 56. The entire assembly then is covered with an appropriate cover (not shown), such as leather, fabric or combination of leather and fabric, particularly stretchable fabric over the air cell cushion.

It will be appreciated that the various embodiments of the motorcycle seat or presented for illustrative purposes only. The scope of the invention is intended to encompass any configuration of seat or saddle that employs a support, a shock absorbing base and one or more air cell cushions positioned at the operator and or passenger seating position. The seat assembly of the present invention includes a cover of durable, wear resistant material that may include a stretchable fabric section at the air cell cushion.

1. A motorcycle seat comprising:
a support;
a shock absorbing base; and
at least one air cell cushion positioned on the base, the air cell cushion having a base and an air array of individual upstanding air cells, said air cells being interconnected so that when the air cells are inflated all exist at the same pressure to exert a generally uniform force or pressure on the anatomical surface area of rider seated on the motorcycle seat.

2. The motorcycle seat of claim 1 comprising two air cell cushions, one said air cell cushion positioned adjacent a rear end of the shock absorbing base and the other air cell cushion positioned in front of the first recited air cell cushion.

3. The motorcycle seat of claim 1 wherein said base and at least one air cell cushion are enclosed in a cover.

4. The motorcycle seat of claim 1 wherein said at least one air cell cushion is operatively connected to a pump apparatus.

5. The motorcycle seat of claim 1 wherein said at least one air cell cushion is positioned in a cavity formed in the shock absorbing base at the approximate ischial area of the rider seated on the motorcycle seat.

6. The motorcycle seat of claim 2 wherein the air cell cushion positioned adjacent a rear end of the shock absorbing base is positioned in a cavity formed in the shock absorbing base at the approximate inshial area of a passenger seated on the motorcycle seat.

7. The motorcycle seat of claim 1 further comprising a support under the shock absorbing base.

8. The motorcycle seat of claim 7 wherein said support has a peripheral configuration complementary to a peripheral configuration of the shock absorbing base.

9. The motorcycle seat of claim 7 wherein said support further comprises mounting hardware for mounting the motorcycle seat to a motorcycle frame.

10. The motorcycle seat of claim 3 wherein the cover is fashioned from leather.

11. The motorcycle seat of claim 1 wherein the individual air cells are four fin air cells.

12. A seat for the operator of a motorcycle, comprising:
a foam base a having substantially triangular configuration, said foam base having a cavity formed therein approximate at an ischial area of the operator seated on the motorcycle seat;
an air cell cushion comprising an array of individual air cells positioned in the cavity and under the approximate ischial area of the operator; and
a cover having a stretchable fabric area positioned over the air cell cushion to allow optimal deflection and equalization of pressure of the air cells.

13. The motorcycle seat of claim 12 wherein the individual air cells are four fin cells.

14. The motorcycle seat of claim 12 further comprising a pump apparatus operatively attached to the air cell cushion for inflating the air cell cushion.

15. A motorcycle seat comprising:
a support for mounting on a frame of the motorcycle;
a shock absorbing foam base on the support, said foam base having a forward cavity formed therein and a rear cavity formed therein;
a first air cell cushion comprising an array of individual air cells positioned in the cavity and under an approximate ischial area of an operator seated on the motorcycle seat;
a second air cell cushion comprising an array of individual air cells positioned in the cavity and under an approximate ischial area of a passenger seated on the motorcycle seat; and
a cover enclosing the base and the first and second air cells.

16. The motorcycle seat of claim 15 further comprising an air pump apparatus operatively associated with at least one of said first or second air cell cushions.
